(19) United States
(12) Patent Application Publication
(10) Pub. No.: US 2012/0320016 A1
(43) Pub. Date: Dec. 20, 2012

(54) THREE-DIMENSIONAL IMAGE DISPLAY DEVICE, THREE-DIMENSIONAL IMAGE DISPLAY SYSTEM, AND METHOD FOR DRIVING THREE-DIMENSIONAL IMAGE DISPLAY DEVICE

(76) Inventor: Mitsuaki Hirata, Osaka-shi, Osaka (JP)

(21) Appl. No.: 13/580,442

(22) PCT Filed: Nov. 30, 2010
(86) PCT No.: PCT/JP2010/071382

§ 371 Date: Aug. 22, 2012

(30) Foreign Application Priority Data
Feb. 24, 2010 (JP) 2010-039284

(51) Int. Cl. G09G 5/00; G09G 3/30; G09G 3/36

(52) U.S. Cl. 345/208; 345/94; 345/76

(57) ABSTRACT

Disclosed is a liquid crystal display device (10) including a matrix of pixels P. Each pixel P includes: a pixel electrode (30) to which a data potential supplied via a source wire (12) is applied; a retention capacitor (33) for storing the data potential temporarily before the data potential is applied to the pixel electrode (30); a transistor (31), connected to a gate wire (11a) for scanning and the source wire (12), for applying the data potential supplied via the source wire (12) to the retention capacitor (33); a transistor (34) for use in collective charging, provided between the retention capacitor (33) and the pixel electrode (30), for applying to the pixel electrode (30) the data potential temporarily applied across the retention capacitor (33); and a transistor (35) for use in collective discharging, connected to the pixel electrode (30), for discharging the pixel electrode. A liquid crystal display device for shutter glass technique is hence achieved which is capable of displaying a bright three-dimensional image without increasing frame frequency.

### TECHNICAL FIELD

The present invention relates to a three-dimensional image display device for displaying a three-dimensional image by displaying one of a left-eye image and a right-eye image alternately in each frame period by time division, and also to a three-dimensional image display system incorporating the three-dimensional image display device.

### BACKGROUND ART

Demands for liquid crystal display device, etc. as flat panel display devices have been growing rapidly in recent years. Liquid crystal display devices have found a wide range of applications, including television sets, mobile phones, mobile game machines, onboard navigation devices for use in vehicles, because they consume less power and are easier to reduce in size than CRT (Cathode Ray Tube) display devices.

Meanwhile, image display technology has been proposed which realizes a three-dimensional display (3D display) in various display devices. For example, for the CRT display device, technology has been proposed which enables to display a three-dimensional image to the user by displaying one of a left-eye image and a right-eye image alternately in each frame period by time division and having the user wear shutter glasses provided with a left-eye shutter and a right-eye shutter for closing and opening a left eye and a right eye of the glasses, respectively.

Also, for the liquid crystal display device, an image display method has been proposed based on three-dimensional image display technology which utilizes the shutter glasses (see Patent Literatures 1 and 2).

As an example, Patent Literature 1 proposes a method of opening and closing the shutter glasses so as to display, in frame periods for the left-eye video and the right-eye video displayed by the liquid crystal display device, only the left-eye video to the left eye during the vertical blanking period of the liquid crystal display device and only the right-eye video to the right eye during the vertical blanking period of the liquid crystal display device. The method eliminates the “crosstalk” problems in which a mixture of the left-eye image and the right-eye image is displayed to the user. The following description will elaborate on this point.

FIG. 11 shows timing charts for the control of the opening and closing of the shutter glasses according to the method described in Patent Literature 1.

In FIG. 11, 206 is a schematic showing an image data output on the liquid crystal display device which alternately displays one of the left-eye image (Left1, Left2, . . . ) and the right-eye image (Right1, Right2, . . . ) in each frame period by time division. The liquid crystal display device is provided with: shutter glasses including a liquid crystal shutter L (left-eye shutter) for closing and opening the left eye and a liquid crystal shutter R (right-eye shutter) for closing and opening the right eye; and a liquid crystal shutter control section for controlling the opening and closing of the individual liquid crystal shutters L and R of the shutter glasses. FIG. 11 shows a timing chart for a liquid crystal shutter L control signal 208 through which the opening and closing of the liquid crystal shutter L is controlled and a timing chart for a liquid crystal shutter R control signal 209 through which the opening and closing of the liquid crystal shutter R is controlled.

As illustrated in FIG. 11, in each frame period for an actual liquid crystal display device, there exists an superposition period 501, 502, and 503 during which pixel data is actually transmitted according to a vertical sync signal and a vertical blanking period 504 during which the pixel data transmission is suspended until a next frame period starts. In the superposition period 501, 502, and 503, an image for the current frame period (e.g., left-eye image Left1) is rewritten to an image for the next frame period (e.g., right-eye image Right1); therefore, the images for the current and next frame periods appear being superposed on each other. In contrast, in the vertical blanking period 504, only the left- or right-eye image is displayed without being mixed.

If the left-eye shutter and the right-eye shutter are simply opened and closed alternately frame period by frame period in the liquid crystal display device as described above, the presence of the superposition period 501, 502, and 503 still enables the user to see an image display in which the right-eye image and the left-eye image are superposed, which hinders a three-dimensional display.

The problem is addressed by the method of Patent Literature 1 according to which, as illustrated in FIG. 11, the liquid crystal shutter control section controls the liquid crystal shutters L and R of the shutter glasses to respectively open the left eye and the right eye only during the vertical blanking period 504 for the liquid crystal display device in each frame period for the left-eye image and the right-eye image displayed by the liquid crystal display device.

The control enables only the left-eye image and the right-eye image, free from mixture of the right-eye image and the left-eye image, to be displayed to the user, thereby achieving a three-dimensional image display with the liquid crystal display device.

### CITATION LIST

### Patent Literature

Patent Literature 1

Japanese Patent Application Publication, Tokukai, No. 2009-152897A (Published Jul. 9, 2009)

Patent Literature 2

Japanese Patent Application Publication, Tokukai, No. 2009-232249A (Published Oct. 8, 2009)

Patent Literature 3

Japanese Patent Application Publication, Tokukai, No. 2008-241832A (Published Oct. 9, 2008)

Patent Literature 4

Japanese Patent Application Publication, Tokukai, No. 2005-45629A (Published Feb. 17, 2005)

### SUMMARY OF INVENTION

### Technical Problem

According to the aforementioned method whereby the shutter glasses are opened only during the vertical blanking period, each liquid crystal shutter is only opened about a quarter of all frames for either the left-eye image or the right-eye image. In addition, for full high vision TV signals, the open period is even shorter due to transmission velocity and other constraints; the liquid crystal shutter is opened no more than 15% (in practice, a mere 4%) of all frames. Therefore, the entire screen becomes dark, making the three-dimensional image being displayed difficult to recognize.

This problem is addressed by the image display method of Patent Literature 2 whereby a first left-eye frame L1 and a second left-eye frame L2 which is identical to the first left-eye frame L1 are sequentially displayed during a display period for the left-eye image, and a first right-eye frame R1 and a second right-eye frame R2 which is identical to the first right-eye frame R1 are sequentially displayed during a display period for the right-eye image. Patent Literature 2 mentions that these two successive displays of the same image frame in each display period for the right-eye image and the left-eye image extend the time during which the right-eye image frame and the left-eye image frame are individually established, and make the three-dimensional image being displayed easier to recognize.

However, when the above display driving method is used for moving images, the shutter opening/closing becomes visible (as flickering), leading to poor display quality, unless high speed drive with a frame frequency of about 240 Hz or even higher is done. This high speed drive could undesirably place a heavy workload on drive circuitry and result in increased cost.

In addition, although Patent Literature 2 allows for an extended open period for the liquid crystal shutters when compared with Patent Literature 1, the liquid crystal shutters can basically be open no longer than about ½ of a whole frame period.

The present invention, conceived in view of these problems, has an object to provide a three-dimensional image display device, as well as a three-dimensional image display system, which work with shutter glasses (shutter glass technique) and are capable of displaying a bright three-dimensional image without increasing the frame frequency.

### Solution to Problem

A three-dimensional image display device in accordance with the present invention, to attain the object, is a three-dimensional image display device for displaying a left-eye image and a right-eye image by time division to realize a three-dimensional image display, the three-dimensional image display device including a display panel, the display panel including: a plurality of data signal lines; a plurality of scan signal lines which intersect the plurality of data signal lines; and a matrix of pixel sections provided corresponding to intersections of the plurality of data signal lines and the plurality of scan signal lines, each of the pixel sections including: a first switching element connected to one of the plurality of scan signal lines and one of the plurality of data signal lines; a first retention capacitor section which contributes to display by storing a data potential supplied via the one of the plurality of data signal lines; a second retention capacitor section for storing the data potential temporarily before the data potential is applied across the first retention capacitor section; and a second switching element provided between the first retention capacitor section and the second retention capacitor section, wherein: in response to a scan signal supplied via the one of the plurality of scan signal lines, the first switching element turns on to apply, to the second retention capacitor section, the data potential supplied via the one of the plurality of data signal lines; and the second switching element is off while the plurality of scan signal lines are being scanned, and upon being switched on, applies the data potential to the first retention capacitor section so as to switch over which one of the left-eye image and the right-eye image is displayed by the pixel sections.

A three-dimensional image display device in accordance with the present invention is a display device effecting a three-dimensional image display by shutter glass technique. The display device in accordance with the present invention includes a matrix of pixel sections each of which is provided with: in addition to a first retention capacitor section (which corresponds to a liquid crystal capacitor in a case of a liquid crystal display device) and a switching element (first switching element) which are included in a typical liquid crystal display panel; a second retention capacitor for temporarily storing a data potential; and a switching element (second switching element) which, upon being turned on while the plurality of scan signal lines are not being scanned (flyback period), applies a data potential to the first retention capacitor section and switches the left-eye image and the right-eye image displayed by the pixel sections.

According to the arrangement, there is provided a second retention capacitor section which stores a data potential temporarily before the data potential is applied across the first retention capacitor section. The plurality of scan signal lines can be thus scanned to sequentially charge the second retention capacitor section in each pixel to a data potential which corresponds to a next set of image data (next frame) while a display is being generated according to a data potential which (i) corresponds to a current set of image data (current frame) and (ii) is being stored in the first retention capacitor section.

Then, by collectively switching the second switching element in each pixel from OFF to ON while the plurality of scan signal lines are not being scanned, the data potential which (i) corresponds to the next set of image data and (ii) has been stored in the second retention capacitor section can be collectively applied across the first retention capacitor section in each pixel section in the display panel.

The first retention capacitor sections which contribute to a display made by the pixels can be thus charged collectively for each frame of image data (on a frame-to-frame basis). Therefore, image “delay” for each frame period, which is unique to those display panels which are subjected to line sequential scanning, occurs less frequently. Hence, when a display device arranged as described above is observed through a pair of shutter glasses, the right-eye image and the left-eye image are prevented from being mixed even if the left-eye shutter and the right-eye shutter of the shutter glasses are designed to be open for a relatively long period. The device therefore enables overlapping images to be restrained and a bright three-dimensional image to be displayed, without increasing frame frequency.

A three-dimensional image display system in accordance with the present invention, to attain the object, includes: the three-dimensional image display device; and a shutter section selectively permitting the left-eye image and the right-eye image to pass through the shutter section to reach a left eye and a right eye, respectively, correspondingly to the left-eye image and the right-eye image.

A three-dimensional image display system in accordance with the present invention realizes a three-dimensional image display by shutter glass technique. The three-dimensional image display system in accordance with the present invention includes a three-dimensional image display device in accordance with the present invention, and is therefore capable of displaying a bright three-dimensional image without increasing frame frequency. A viewer viewing an image using a shutter section can hence view a bright three-dimensional image without experiencing overlapping of a left-eye image and a right-eye image.

A method of driving a three-dimensional image display device in accordance with the present invention is a method of driving a three-dimensional image display device of the present invention, the method including the steps of: turning on the first switching element, with the second switching element turned off, while a data potential in accordance with a current one of plural sets of image data for time divisional display is stored in the first retention capacitor section, and charging the second retention capacitor section to a data potential in accordance with a next one of the plural sets of image data for time divisional display; and turning on the second switching element in each pixel collectively, with the first switching element turned off, to collectively apply, to the first retention capacitor section in each pixel, the data potential which (i) corresponds to the next set of image data and (ii) has been stored in the second retention capacitor section to realize a display according to the data potential.

According to the method, there is provided a second retention capacitor section which stores a data potential temporarily before the data potential is applied across the first retention capacitor section. The plurality of scan signal lines can be thus scanned to sequentially charge the second retention capacitor section in each pixel to a data potential which corresponds to a next set of image data (next frame) while a display is being generated according to a data potential which (i) corresponds to a current set of image data (current frame) and (ii) is being stored in the first retention capacitor section.

Then, by collectively switching the second switching element in each pixel from OFF to ON while the plurality of scan signal lines are not being scanned, the data potential which (i) corresponds to the next set of image data and (ii) has been stored in the second retention capacitor section can be collectively applied across the first retention capacitor section in each pixel section in the display panel.

The first retention capacitor sections which contribute to a display made by the pixels can be thus charged collectively for each frame of image data (on a frame-to-frame basis). Therefore, image “delay” for each frame period, which is unique to those display panels which are subjected to line sequential scanning, occurs less frequently. Hence, when an image displayed by the method is viewed through a pair of shutter glasses, the right-eye image and the left-eye image are prevented from being mixed even if the left-eye shutter and the right-eye shutter of the shutter glasses are designed to be open for a relatively long period. The method therefore enables overlapping images to be restrained and a bright three-dimensional image to be displayed, without increasing frame frequency.

### Advantageous Effects of Invention

The three-dimensional image display device and the three-dimensional image display system in accordance with the present invention enable overlapping images to be restrained and a bright three-dimensional image to be displayed, without increasing frame frequency.

### BRIEF DESCRIPTION OF DRAWINGS

FIG. 1 is a schematic view showing an arrangement for a three-dimensional image display system in accordance with an embodiment of the present invention. This Fig. depicts a liquid crystal shutter L being closed.

FIG. 2 is a schematic view showing an arrangement for a three-dimensional image display system in accordance with an embodiment of the present invention. This Fig. depicts a liquid crystal shutter R being closed.

FIG. 3 is a plan view showing an arrangement for an entire liquid crystal display device incorporated in a three-dimensional image display system in accordance with an embodiment of the present invention.

FIG. 4 is an equivalent circuit diagram showing an arrangement for a pixel in the liquid crystal display panel shown in FIG. 3.

FIG. 5 is a plan view showing an arrangement for a pixel in the liquid crystal display panel shown in FIG. 3.

FIG. 6 is a schematic view showing a relationship between a frame data output to the liquid crystal display panel and control signal timings through which the opening and closing of shutter glasses is controlled, according to an embodiment of the present invention.

FIG. 7 is a timing chart showing timings of signals supplied to various wires and changes in electric potential of a retention capacitor and a pixel electrode, according to an embodiment of the present invention.

FIG. 8 is a graphical representation of a relationship between the ratio of capacitances of the retention capacitor and the liquid crystal capacitor (C33/C32) and voltage Vpx applied to a pixel electrode.

FIG. 9 is an equivalent circuit diagram showing another example of a pixel in the liquid crystal display panel shown in FIG. 3.

FIG. 10 is an equivalent circuit diagram showing an arrangement for a pixel in a three-dimensional image display device in accordance with another embodiment of the present invention.

FIG. 11 is a timing chart for control signals through which the opening and closing of shutter glasses is controlled in a conventional three-dimensional image display device.

FIG. 12 is an equivalent circuit diagram showing an arrangement for a pixel in a conventional organic EL display device.

### DESCRIPTION OF EMBODIMENTS

The following will describe an embodiment of the present invention in reference to FIGS. 1 to 10. Note that the present invention is by no means limited to this embodiment.

A liquid crystal display device (display device) for a three-dimensional image display by shutter glass technique and a three-dimensional image display system arranged to include the liquid crystal display device and shutter glasses will be described in the present embodiment. In this context, the three-dimensional image display by shutter glass technique is technology for displaying one of a left-eye image and a right-eye image alternately in each frame period by time division to a user wearing a pair of shutter glasses provided with a left-eye shutter and a right-eye shutter for closing and opening a left eye and a right eye of the glasses respectively, so that the user can view a three-dimensional image.

### (Arrangement of Three-dimensional Image Display System)

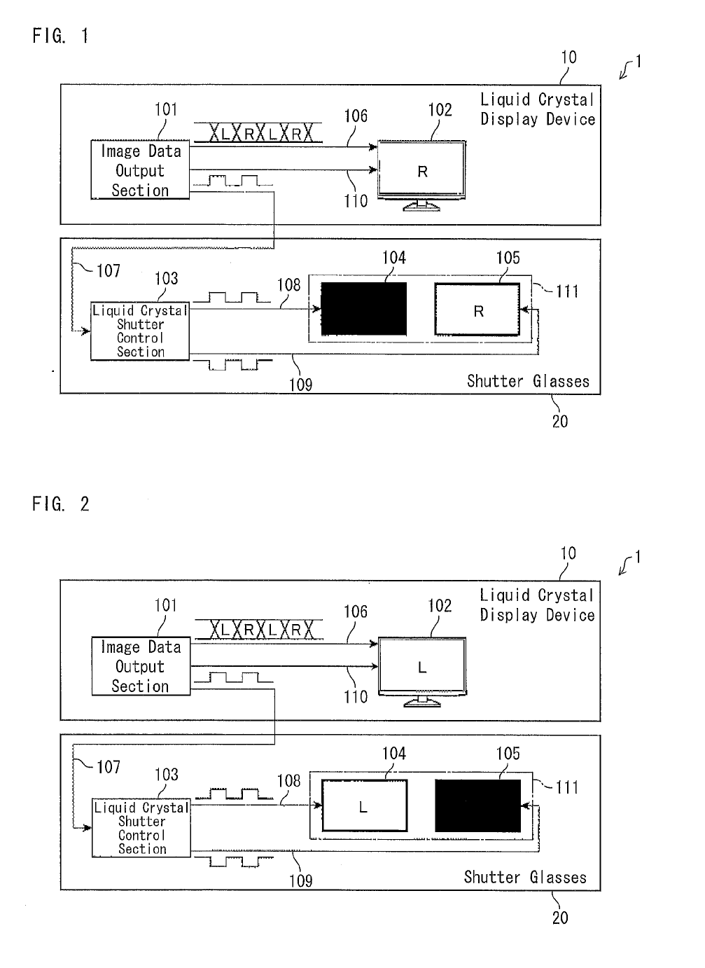

FIGS. 1 and 2 illustrate an exemplary arrangement for a three-dimensional image display system in accordance with the present embodiment, respectively showing a liquid crystal shutter L and a liquid crystal shutter R being closed. A three-dimensional image display system 1 in accordance with the present embodiment is arranged to include a liquid crystal display device 10 and a pair of shutter glasses (shutter section) 20. The liquid crystal display device 10 includes a liquid crystal display panel 102 which displays one of a left-eye image and a right-eye image alternately in each frame period by time division. On the liquid crystal display panel 102, the user can view a three-dimensional image by wearing the shutter glasses 20 provided with a left-eye shutter for closing and opening the left eye and a right-eye shutter for closing and opening the right eye.

As illustrated in FIGS. 1 and 2, the three-dimensional image display system in accordance with the present embodiment is provided with: the liquid crystal display device 10 including an image data output section 101 and the liquid crystal display panel 102; and the shutter glasses 20 including a liquid crystal shutter control section (shutter control section) 103 and a glasses section 111. The glasses section 111 includes a liquid crystal shutter L (left-eye shutter) 104 and a liquid crystal shutter R (right-eye shutter) 105.

The image data output section 101 transmits frame data 106 to the liquid crystal display panel 102 for an image output on the liquid crystal display panel 102. In the present embodiment, the image data output section 101 transmits left-eye image data and right-eye image data sequentially. Simultaneously, the image data output section 101 outputs a frame control signal 107 which indicates frame status. The image data output section 101 also transmits a backlight control signal 110 to the liquid crystal display panel 102 to control lighting of a backlight in the liquid crystal display panel 102. The image data output section 101 transmits, to the liquid crystal shutter control section 103, data (here, the frame control signal 107) which specifies opening and closing timings for the shutters of the shutter glasses 20.

The liquid crystal display panel 102 displays, as an image, the frame data 106 outputted from the image data output section 101.

The liquid crystal shutter control section 103 controls the opening/closing of the liquid crystal shutter L 104 and the liquid crystal shutter R 105 through a liquid crystal shutter L control signal 108 and a liquid crystal shutter R control signal 109 respectively. In FIG. 1, the liquid crystal shutter R 105 is open, and the liquid crystal shutter L 104 is closed. In contrast, in FIG. 2, the liquid crystal shutter L 104 is open, and the liquid crystal shutter R 105 is closed.

The liquid crystal shutter L 104 of the glasses section 111 is intended for use as a left-side lens for the shutter glasses. The liquid crystal shutter L 104 contains liquid crystal molecules therein. The opening and closing of the shutter can be controlled by changing the orientation of the liquid crystal molecules. Specifically, the liquid crystal shutter L 104 is adapted so that the user's left eye can see an image displayed on the liquid crystal display panel 102 when the shutter is open, but cannot see anything when the shutter is closed.

The liquid crystal shutter R 105 of the glasses section 111 is intended for use as a right-side lens for the shutter glasses. The liquid crystal shutter R 105 also contains liquid crystal molecules therein. The opening and closing of the shutter can be controlled by changing the orientation of the liquid crystal molecules. Specifically, the liquid crystal shutter R 105 is adapted so that the user's right eye can see an image displayed on the liquid crystal display panel 102 when the shutter is open, but cannot see anything when the shutter is closed.

### (Arrangement of Liquid Crystal Display Device)

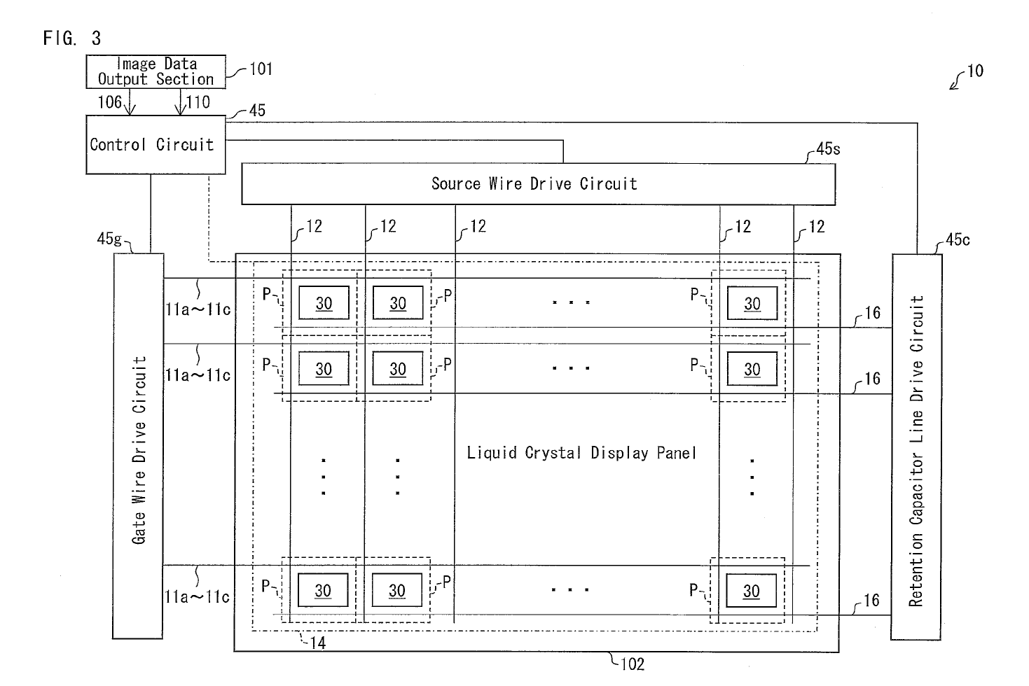

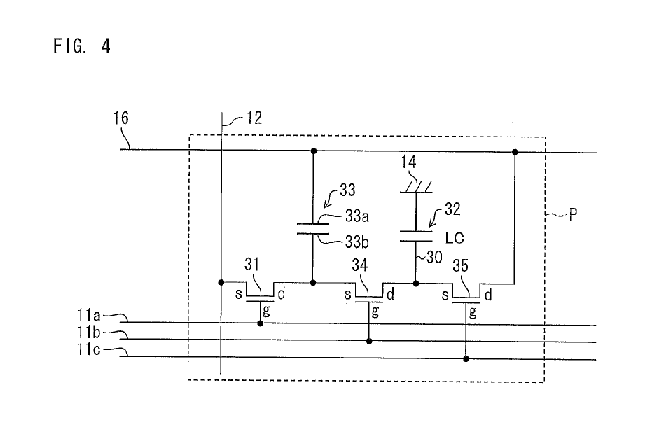

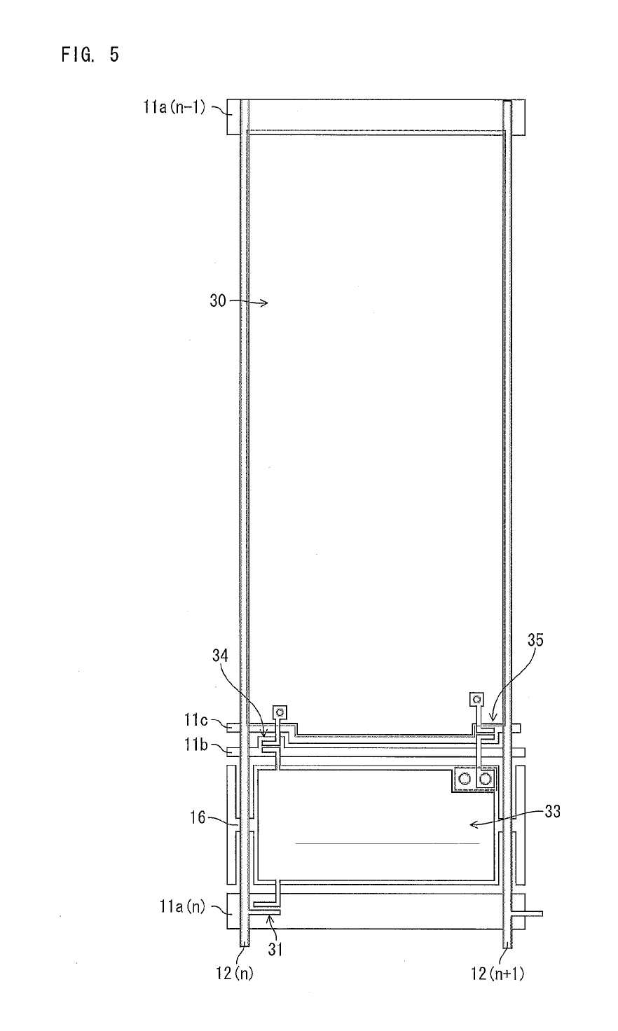

Referring to FIGS. 3, 4, and 5, the following will more specifically describe an arrangement of the liquid crystal display device 10 and the liquid crystal display panel 102 which is provided in the device 10. FIG. 3 is a plan view showing an overall arrangement of the liquid crystal display device 10. FIG. 4 is an equivalent circuit diagram showing an arrangement of one of pixels (pixel sections) P which constitute the liquid crystal display panel 102. FIG. 5 is a plan view showing the arrangement of the pixel P.

As illustrated in FIG. 3, the liquid crystal display device 10 includes the liquid crystal display panel 102 of active matrix type, a source wire drive circuit 45s, a gate wire drive circuit 45g, a retention capacitor line drive circuit 45c, the image data output section 101, and a control circuit 45.

The liquid crystal display panel 102 is constructed by interposing liquid crystal between an active matrix substrate and a counter substrate and includes a matrix of numerous pixels P.

As illustrated in FIGS. 4 and 5, the liquid crystal display panel 102 includes: on the active matrix substrate, gate wires (scan signal lines) 11a for use in scanning; gate wires (first control wires) 11b for use in collective charging; gate wires (second control wires) 11c for use in collective discharging; source wires (data signal lines) 12; transistors (first switching elements) 31, transistors (second switching elements) 34, and transistors (third switching elements) 35, each transistor serving as a switching element; pixel electrodes 30; and retention capacitor lines 16 (may be referred to as “CS wires”). The liquid crystal display panel 102 further includes a counter electrode 14 on the counter substrate. Note that although FIG. 3 shows the three types of gate wires 11a, 11b, and 11c as a single wire, these gate wires are actually formed individually (see FIGS. 4 and 5). The transistors 31, 34, and 35 are shown in FIGS. 4 and 5, but omitted in FIG. 3.

The source wires 12 (12(n) and 12(n+1) in FIG. 5) are formed, one in each column, so as to extend parallel to each other in a column direction (longitudinal direction). The gate wires 11a (11a(n−1) and 11a(n) in FIG. 5) are formed, one in each row, so as to extend parallel to each other in a row direction (latitudinal direction). The transistor 31 and the pixel electrode 30 are formed at the intersections of the source wire 12 (12(n)) and the gate wire 11a (11a(n)). The pixel electrode 30 forms a liquid crystal capacitor 32 between itself and the counter electrode 14, with liquid crystal being interposed between the pixel electrode 30 and the counter electrode 14. The retention capacitor lines 16 are formed, one in each row, so as to extend parallel to each other in the row direction (latitudinal direction). The retention capacitor lines 16 are provided so that each one of them makes a pair with a different combination of the three gate wires 11a to 11c.

### (Specific Arrangement of Pixel P)

Referring to FIGS. 4 and 5, the following will more specifically describe an arrangement of a pixel P. As illustrated in FIGS. 4 and 5, the pixels P each include therein: the three transistors 31, 34, and 35; the pixel electrode 30 and the counter electrode 14 for forming the liquid crystal capacitor (first retention capacitor section) 32; and a pair of retention capacitor electrodes 33a and 33b for forming a retention capacitor (second retention capacitor section) 33.

The transistor 31 has its source electrode “s” connected to the source wire 12 and its gate electrode “g” connected to the gate wires 11a for use in scanning. The transistor 31 has its drain electrode “d” connected to the source electrode “s” of the transistor 34 and also to one of the electrodes, 33b, of the retention capacitor 33.

The transistor 34 has its source electrode “s” connected to the drain electrode “d” of the transistor 31 and its gate electrode “g” connected to the gate wire 11b for use in collective charging. The transistor 34 has its drain electrode “d” connected to the pixel electrode 30 and also to the source electrode “s” of the transistor 35.

The transistor 35 has its source electrode “s” connected to the drain electrode “d” of the transistor 34, its gate electrode “g” connected to the gate wire 11c for use in collective discharging, and its drain electrode connected to the retention capacitor line 16.

The pixel electrode 30 forms the liquid crystal capacitor (LC) (first retention capacitor section) 32 between itself and the counter electrode 14, with liquid crystal being interposed between the pixel electrode 30 and the counter electrode 14. The retention capacitor 33 has the other electrode 33a connected to the retention capacitor line 16. The retention capacitor 33, formed by the pair of electrodes 33a and 33b, functions as a charging capacitor internal to the pixel, so that the electric potential to be applied to the pixel electrode 30 can be stored temporarily before being applied to the pixel electrode 30.

In the pixel P thus arranged, the gate of the transistor 31 temporarily turns on in response to a gate signal (scan signal) supplied to the gate wire 11a for use in scanning, so that the electric potential which is in accordance with the source signal (data signal) from the source wire 12 can be stored temporarily in the retention capacitor 33.

The pixel P includes the (second) transistor 35. The gate electrode “g” of the transistor 35 receives a gate signal from the gate wire 11c at such a timing that the transistor 35 in every pixel in the liquid crystal display panel 102 is simultaneously turned on while the transistor 31 is off. Accordingly, all the pixel electrodes 30 in the liquid crystal display panel 102 are collectively discharged. For this reason, the transistor 35 is referred to as the transistor for use in collective discharging, and the gate wire 11c connected to the gate electrode “g” of the transistor 35 is referred to as the gate wire for use in collective discharging.

The pixel P further includes the (third) transistor 34. The transistor 34 turns on in response to a gate signal (control signal) supplied to the gate wire 11b, so that the electric potential having been stored in the retention capacitor 33 can be applied to the pixel electrode 30. Accordingly, a grayscale display in accordance with the source signal is obtained by setting the pixel electrode 30 to the electric potential which is in accordance with the source signal so as to apply a voltage which is in accordance with the source signal across the liquid crystal interposed between the pixel electrode 30 and the counter electrode 14.

Note that the gate wire 11b supplies the gate signal at such a timing that the transistor 34 in every pixel in the liquid crystal display panel 102 is simultaneously turned on. Accordingly, all the pixel electrodes 30 in the liquid crystal display panel 102 are collectively charged. For this reason, the transistor 34 is referred to as the transistor for use in collective charging, and the gate wire 11b connected to the gate electrode “g” of the transistor 34 is referred to as the gate wire for use in collective charging.

Timings at which the transistors 31, 34, and 35 are turned on/off in the pixel P will be described later in detail.

### (Circuitry in Liquid Crystal Display Device 10)

The liquid crystal display panel 102, arranged as described above, is driven by the source wire drive circuit 45s, the gate wire drive circuit 45g, the retention capacitor line drive circuit 45c, and the control circuit 45 which controls these drive circuits 45s, 45g, and 45c.

In the present embodiment, horizontal scan periods for individual rows are sequentially allocated to the active periods (effective scan periods) in a periodically repeated vertical scan period, to sequentially scan the rows.

For this purpose, the gate wire drive circuit 45g sequentially outputs, in synchronism with the horizontal scan period (1H) for each row, a gate signal which turns on the transistor 31 to the gate wire 11a for that row.

The gate wire drive circuit 45g outputs a gate signal which turns on the transistor 35 to each gate wire 11c, so as to collectively discharge the pixel electrodes 30 of all the pixels P in the liquid crystal display panel 102.

The gate wire drive circuit 45g outputs a gate signal which turns on the transistor 34 to each gate wire 11b, so as to collectively charge the pixel electrodes 30 of all the pixels P in the liquid crystal display panel 102.

The source wire drive circuit 45s then outputs a source signal to each source wire 12. This source signal is obtained in the source wire drive circuit 45s through a process which includes, for example, allocating to each column an image signal (frame data 106) supplied from the image data output section 101 to the source wire drive circuit 45s through the control circuit 45 and increasing voltage of a resultant signal.

The retention capacitor line drive circuit 45c supplies a fixed-voltage signal to each retention capacitor line 16 to fix the voltage on one of the electrodes, 33a, of the retention capacitor 33.

The control circuit 45 controls the gate wire drive circuit 45g, the source wire drive circuit 45s, and the retention capacitor line drive circuit 45c according to the image signal (frame data 106) transmitted from the image data output section 101, so that these circuits can output the gate signal, the source signal, and the CS signal respectively. The control circuit 45 further controls lighting on/off of a backlight (not shown) according to the backlight control signal 110 transmitted from the image data output section 101.

(Relationship between Frame Data and Timings at which Shutter Glasses are Opened and Closed)

The following will describe a relationship between a frame data output to the liquid crystal display panel 102 and timings at which the shutter glasses 20 are opened and closed.

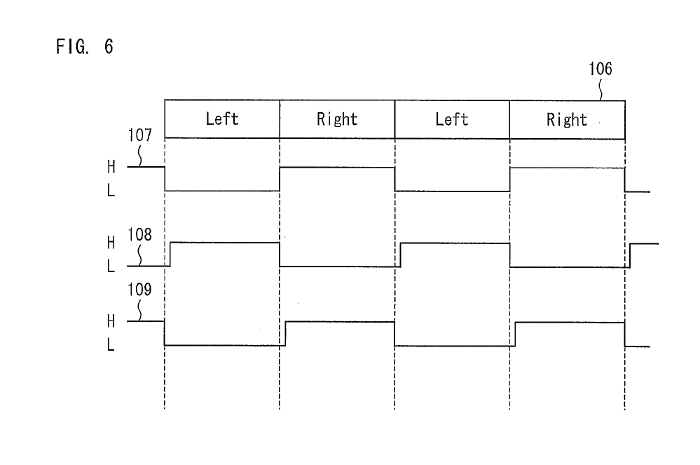

FIG. 6 shows a relationship between a frame data output to the liquid crystal display panel 102 and control signal timings through which the opening and closing of the shutter glasses 20 is controlled. The frame data 106 is image data outputted to the liquid crystal display panel 102. In the present embodiment, the image data output section 101 transmits, in each frame, the frame control signal 107 indicative of a timing of switching the right-eye image and the left-eye image.

The frame control signal 107 is indicative of the status of the frame data 106. In the present embodiment, as illustrated in FIG. 6, the frame control signal 107 outputted from the image data output section 101 goes LOW when a left-eye part of the frame data 106 is being outputted and goes HIGH when a right-eye part of the frame data 106 is being outputted. The frame control signal 107 outputted from the image data output section 101 is transmitted to the liquid crystal shutter control section 103 provided in the shutter glasses 20.

Specifically, in a normal state, the liquid crystal shutter L 104 is on (opened), and the liquid crystal shutter R 105 is off (closed). An infrared pulse signal is sent when the frame control signal 107 is HIGH. Upon the liquid crystal shutter control section 103 recognizing this infrared pulse signal, the liquid crystal shutter L 104 turns off, and the liquid crystal shutter R 105 turns on. In this manner, the liquid crystal shutter is controlled in synchronism with the image data.

The liquid crystal shutter L control signal 108 is a signal for controlling the opening/closing of the liquid crystal shutter L 104. The liquid crystal shutter R control signal 109 is a signal for controlling the opening/closing of the liquid crystal shutter R 105. These signals have a pattern which will be described later in detail.

The following will describe operation of a three-dimensional image display device in accordance with the present embodiment. In the present embodiment, the image data output section 101 outputs the frame data 106 and the frame control signal 107. The right-eye image and the left-eye image for the frame data 106 are sequentially transmitted. The liquid crystal display panel 102 receives the frame data 106 for image output.

The liquid crystal shutter control section 103 controls the opening/closing of the liquid crystal shutter L 104 and the liquid crystal shutter R 105 according to the frame control signal 107. The liquid crystal shutter control section 103 opens the liquid crystal shutter R 105 (closes the liquid crystal shutter L 104) when the right-eye image is being displayed on the liquid crystal display panel 102, and opens the liquid crystal shutter L 104 (closes the liquid crystal shutter R 105) when the left-eye image is being displayed.

Such control basically enables a three-dimensional image display. The image display on the liquid crystal display panel, however, entails overlapping of image frames due to image “delay” which occurs in each frame period. This delay is absent in the CRT display device and unique to the liquid crystal display panel.

To eliminate the overlapping, in the present embodiment, when the frame control signal 107 switches between HIGH and LOW, the liquid crystal shutter L control signal 108 (or the liquid crystal shutter R control signal 109) switches from LOW (closed) to HIGH (open) with a small delay, as illustrated in FIG. 6. In contrast, the liquid crystal shutter L control signal 108 and the liquid crystal shutter R control signal 109 both switch from HIGH (open) to LOW (closed) (the signals fall) in synchronism with the timing of the frame control signal 107 switching between HIGH and LOW. Accordingly, there are provided periods during which the liquid crystal shutters L and R are both closed. During the periods, only the left- or right-eye image is displayed without being mixed to the user. A good three-dimensional image display is thus achieved.

Instead of controlling the opening and closing timings of the liquid crystal shutters so as to provide the periods during which the shutters L and R are both closed, the backlight may be controlled to turn off during those periods when the frame control signal 107 switches between HIGH and LOW.

In addition, in the present embodiment, the three transistors 31, 34, and 35 provided in each pixel P are controlled to turn on/off at such timings that the liquid crystal capacitors 32 of all the pixels in the liquid crystal display panel 102 are collectively charged and discharged on a frame-to-frame basis. Therefore, the right-eye image and the left-eye image are prevented from being mixed even if the liquid crystal shutter L 104 and the liquid crystal shutter R 105 are designed to be open for a relatively long period. The overlapping images are thus restrained, and a bright three-dimensional image display is achieved, without increasing frame frequency.

### (Operation Timings of Transistors in Each Pixel P)

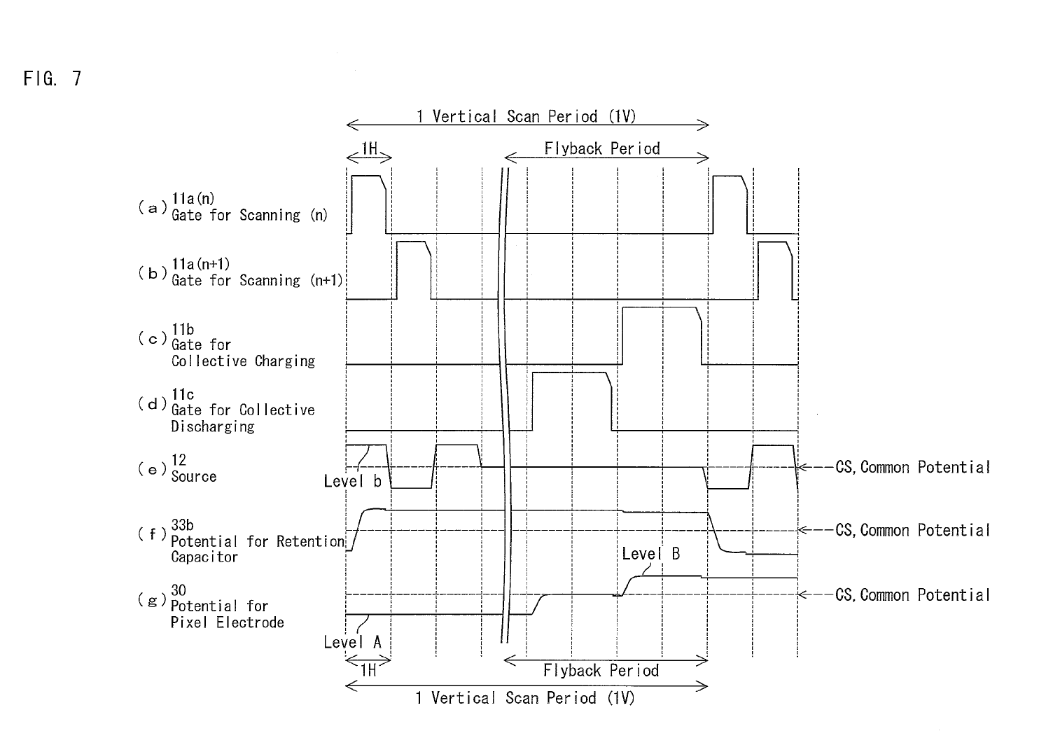

Referring to the timing charts in FIGS. 4 and 7, the following will describe operation timings of the transistors 31, 34, and 35, which realize collective charging and collective discharging of the liquid crystal capacitors 32 in the image display surface described above. The method of driving described here is an application of the frame sequential drive described in Patent Literature 3.

First, the gate of the transistor 31 in each pixel P is turned on by sequentially scanning the gate wires 11a with a gate signal (scan signal) supplied to the gate wires 11a (see (a) and (b) of FIG. 7), while an image is being displayed on the liquid crystal display panel 102 according to frame data which immediately precedes current frame data (in other words, while the liquid crystal capacitor 32 is holding an electric potential indicative of a source signal in accordance with the preceding frame data (level A in (g) of FIG. 7). Thus, the temporarily retention capacitor 33 holds the electric potential (referred to as the data potential, indicated by level b in (e) of FIG. 7) which is in accordance with the source signal (data signal) fed from the source wire 12 during the same horizontal scan period (1H) (see (f) of FIG. 7). The transistors 34 and 35 are off at this timing.

By sequentially scanning the gate wires 11a(n), 11a(n+1), etc. as described above, the retention capacitor 33 in each pixel P comes to hold the data potential.

Subsequently, the transistor 31 is turned off. Thereafter, the transistor 35 is turned on according to a gate signal supplied to the gate wire 11c with the transistor 34 being off (see (d) of FIG. 7). In this context, the gate signal supplied to the gate wire 11c is applied to more than one of the gate wires 11c at the same timing. Accordingly, the electric charge having been stored in the liquid crystal capacitor 32 in each pixel P of the liquid crystal display panel 102 is allowed to flow to the retention capacitor line 16. The liquid crystal capacitors 32 are thus collectively discharged. The electric potential of the pixel electrode 30 then changes to common potential, as shown in (g) of FIG. 7.

Next, the transistor 35 is turned off with the transistor 31 being off. Thereafter, the transistor 34 is turned on according to a gate signal supplied to the gate wire 11b for use in collective charging (see (c) of FIG. 7). In this context, the gate signal supplied to the gate wire 11b for use in collective charging is applied to more than one of the gate wires 11b at the same timing. Accordingly, the electric charge having been stored in the retention capacitor 33 in each pixel P of the liquid crystal display panel 102 flows to the pixel electrode 30. The liquid crystal capacitors 32 are thus collectively charged. The electric potential of the pixel electrode 30 then changes to an electric potential (e.g., level B) in accordance with the data potential (e.g., level b), shown in (g) of FIG. 7.

Thereafter, the transistor 34 is turned off, which allows the liquid crystal capacitor 32 to hold a data potential in accordance with the current frame data so that an image in accordance with current frame data can be displayed.

As described above, according to the arrangement of the present embodiment, the liquid crystal capacitor 32 in each pixel is collectively charged and discharged on a frame-to-frame basis (one vertical scan period or 1 V). Therefore, the right-eye image and the left-eye image are prevented from being mixed even if the liquid crystal shutter L 104 and the liquid crystal shutter R 105 are designed to be open for a relatively long period. The overlapping images are thus restrained, and a bright three-dimensional image display is achieved, without increasing frame frequency.

According to the arrangement, the gate signal for use in collective discharging and the gate signal for use in collective charging can provide a sufficient ON period during a flyback period to avoid influence from signal delay in the collective discharging and collective charging. Therefore, the gate wire 11c for use in collective discharging and the gate wire 11b for use in collective charging may have a width smaller than that of the gate wire 11a for use in scanning. This enables a decrease in aperture ratio to be reduced (see FIG. 5).

Letting Q be the sum of the electric charge Q₃₃ having been stored in the retention capacitor 33 and the residual electric charge Q₃₂ in the pixel P, and C be the sum of the capacitance C₃₃ of the retention capacitor 33, the capacitance C₃₂ of the liquid crystal capacitor 32, and the parasitic capacitance Cₒₜₕₑᵣ of bus lines, etc. (C₃₃+C₃₂+Cₒₜₕₑᵣ), the voltage Vpx applied across the pixel P is given by Vpx=Q/C. Therefore, to obtain a sufficient pixel voltage in comparison with the voltage applied to the source “s” of the transistor 31 (data voltage), C₃₃ needs to be large in comparison with C32.

If decrease in luminance does not exceed approximately 10%, the improved luminance effect of the present invention achieved by the liquid crystal shutters being open is not lost. Therefore, a sufficient pixel voltage target is 6 V when the source application voltage is 7.5 V during a white display.

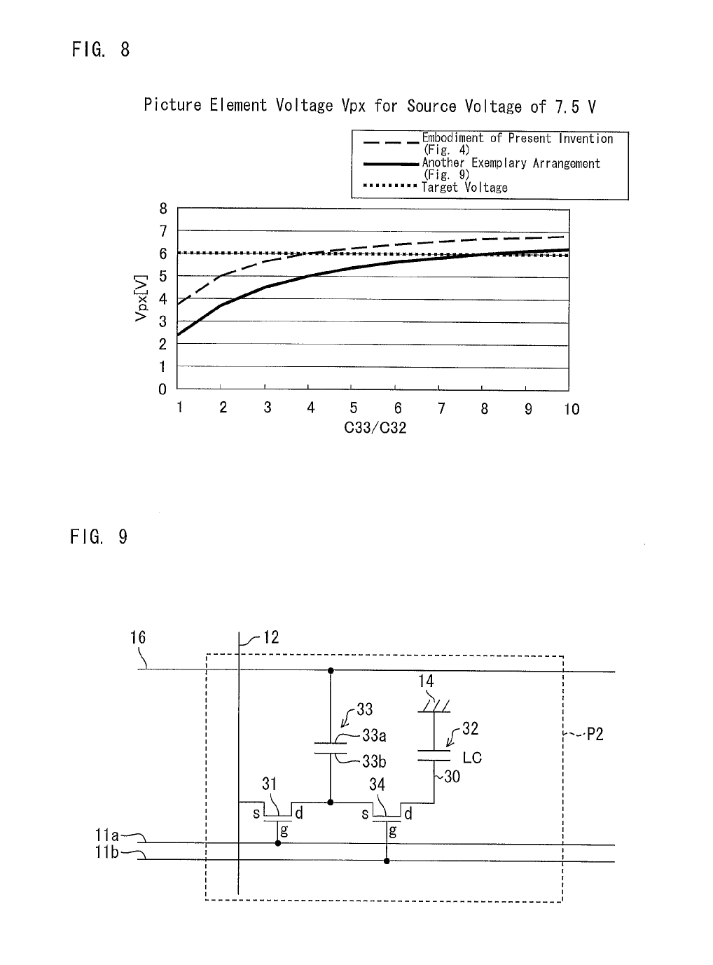

FIG. 8 shows pixel voltages Vpx for some capacitance ratios being plotted on the vertical axis against C₃₃/C₃₂ on the horizontal axis. The graph indicates that C₃₃ needs to be about 4 times C₃₂ to obtain the target voltage of 6 V.

For these reasons, the retention capacitor 33 is desirably at least 4 times as large in capacitance as the liquid crystal capacitor 32 in cases where pixels P are arranged as in the present embodiment.

The following will describe another example of pixels which constitute the liquid crystal display panel 102 shown in FIG. 3. An exemplary arrangement will be described here which includes neither transistors for use in collective discharging nor gate wires for use in collective discharging.

FIG. 9 represents an arrangement of one of pixels P2 which constitute the liquid crystal display panel 102. As could be understood by comparing the pixel P2 shown in FIG. 9 with the pixel P shown in FIG. 4, the pixel P2 has no transistor 35 for use in collective discharging or no gate wire 11c for use in collective discharging. The pixel P2 is otherwise arranged the same way as the pixel P. Members in FIG. 9 are indicated by the same reference numerals and/or symbols as those used for the pixel P, and their descriptions are omitted.

A liquid crystal device provided with the pixels P2 arranged as above is AC-driven. V₃₃ and V₃₂ are therefore always of opposite polarities immediately before the transistor 34 (provided for use in collective charging) is turned on. When the transistor 34 is turned on, the electric charge Q decreases, which results in decrease in picture element voltage. In other words, since polarity is switched by turning on the transistor 34 with no transistor 35 for use in discharging being provided to forcefully decrease the electric charge Q, the electric charge Q temporarily decreases, and hence discharging is practically achieved.

In the case of an arrangement like that of the pixel P2 shown in FIG. 9, C₃₃ needs to be 8 times C₃₂, as indicated in FIG. 8, for Vpx to reach the target voltage of 6 V. In addition, the transistor 31 desirably possesses further improved performance. An increase in transistor size for the purpose of improved performance can lead to a decrease in aperture ratio; to reduce the decrease in aperture ratio, it is desirable to use high mobility TFTs, such as polysilicon TFTs or transparent oxide semiconductor (IGZO) TFTs, not amorphous silicon TFTs.

### Applications of the Present Invention

The three-dimensional image display system 1 of the present embodiment can be implemented using a personal computer. In that case, the personal computer serves as the image data output section 101, a liquid crystal monitor serves as the liquid crystal display panel 102, and an external device serves as the liquid crystal shutter control section 103. The user can view, for example, three-dimensional CAD (Computer Aided Design) data using the system thus implemented.

Alternatively, the three-dimensional image display system 1 of the present embodiment can be implemented using a liquid crystal television. In that case, an image output section in the liquid crystal television serves as the image data output section 101, a liquid crystal panel in the liquid crystal television serves as the liquid crystal display panel 102, and an external device serves as the liquid crystal shutter control section 103. The user can view three-dimensional display software using the system thus implemented, i.e., on a conventional home television.

The present invention is applicable to liquid crystal display devices of any liquid crystal mode, ranging from conventional nematic liquid crystal mode, such as TN mode, VA mode, OCB mode, IPS mode, and in-plane-electric-field vertical alignment mode in which VA liquid crystal is driven by an in-plane electric field, to chiral liquid crystal mode, such as blue phase mode, and to quasi-isotropic liquid crystal mode.

Of these modes, IPS mode and in-plane-electric-field vertical alignment mode especially do not require large picture element capacitance, allowing for small retention capacitor area. This increases aperture ratio and enhances the luminance-improving effect of the present invention.

In addition, in-plane-electric-field vertical alignment mode, OCB mode, chiral liquid crystal mode, and quasi-isotropic liquid crystal mode exhibit high-speed response, allowing for an extended shutter open period. This enhances the luminance-improving effect of the present invention.

### Other Embodiments of the Present Invention

The display device which can be part of the three-dimensional image display system of the present invention is not limited to the liquid crystal display device described above. The present invention is applicable to a display device which performs line sequential scanning, such as an organic EL display device. Accordingly, the following will describe an exemplary arrangement of a three-dimensional image display system incorporating an organic EL display panel in place of a liquid crystal display panel.

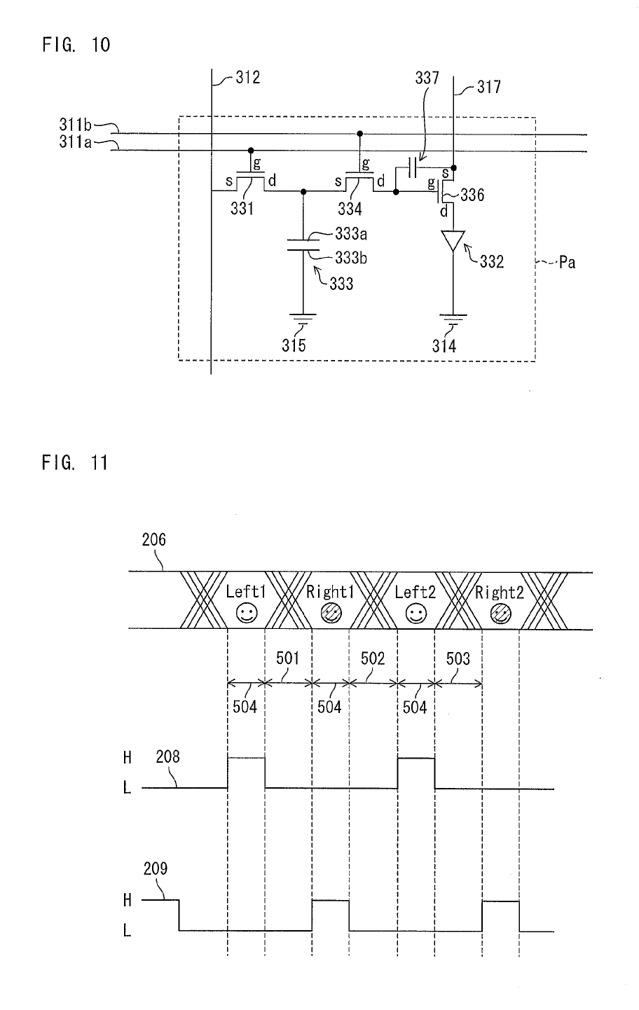

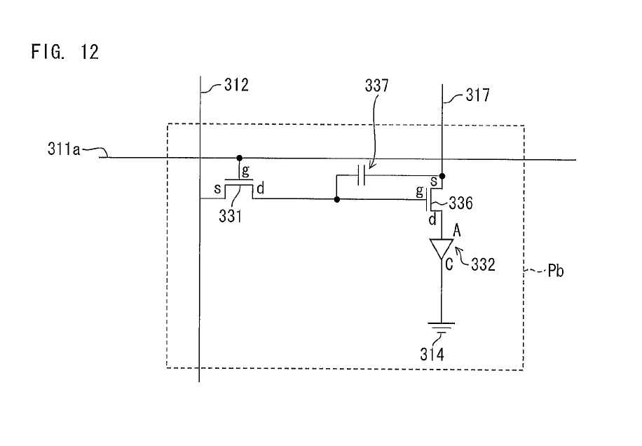

FIG. 10 represents an arrangement of one of pixels (pixel sections) Pa which constitute an organic EL display panel (display panel). FIG. 12 represents an arrangement of one of pixels Pb of a conventional organic EL display panel for comparison.

Firstly, an arrangement of one of pixels of a conventional, typical organic EL display device is described in reference to FIG. 12. A typical organic EL display device includes pixels Pb near intersections of gate wires 311a for use in scanning and source wires (data signal lines) 312 via switching transistors (first switching elements) 331 as illustrated in FIG. 12. The organic EL display device also includes power supply lines 317 parallel to the source wires 312.

Each pixel Pb includes, apart from a transistor 331, an organic EL element 332, a drive transistor 336, a storage capacitor 337, a common electrode 314, etc.

As illustrated in FIG. 12, the switching transistor 331 has its source electrode “s” connected to a source wire 312, its gate electrode “g” connected to a gate wire 311a, and its drain electrode “d” connected to an end of the storage capacitor 337 and to the gate electrode “g” of the drive transistor 336. The other end of the storage capacitor 337 is connected to a power supply line 317 and to the source electrode “s” of the drive transistor. The drive transistor 336 has its source electrode “s” connected to the power supply line 317 and its drain electrode “d” connected to an anode A of the organic EL element 332. The organic EL element 332 has a cathode C connected to the common electrode 314 formed on or above the pixel Pb.

The pixel Pb, arranged as above, operates as follows.

First, when the scan signal on the gate wire 311a is active, the switching transistor 331 is turned on. Thus, the electric charge which corresponds to a data signal value supplied to the source wire 312 is supplied to the gate “g” of the drive transistor 336 through the transistor 331 and simultaneously supplied to and stored in the storage capacitor 337.

Next, the transistor 331 is turned off. After that, the electric charge stored in the storage capacitor 337 is retained. Frame sequential drive is possible, after 1 scan period, by supplying electric power to the drive transistor 336 through the power supply line 317. This is however not preferred in terms of display quality because of limited lighting time and low luminance. Accordingly, the transistor 336 is maintained in the ON state by continuously supplying electric power to the power supply line 317 even when the gate wire 311a is being scanned. The organic EL element 332 therefore continuously emits light by line sequentially drive. The electric charge stored in the storage capacitor 337 allows for control of the ON state of the drive transistor 336, which allows for control of the electric current flow through the organic EL element 332. This in turn enables the organic EL element 332 to emit light with an intensity which corresponds to the data signal value.

Next will be described an arrangement of an organic EL display device in accordance with an embodiment of the present invention, in reference to FIG. 10. Structural members of a pixel Pa in FIG. 10 that are similar to those of the pixel Pb in FIG. 12 are indicated by the same reference numerals and/or symbols, and their descriptions are omitted.

As could be understood by comparing the pixel Pa in FIG. 10 with the pixel Pb in FIG. 12, the arrangement in FIG. 10 includes a gate wire (first control wire) 311b for use in collective charging parallel to a gate wire (scan signal line) 311a. The pixel Pa is further provided with a transistor for use in collective charging and a retention capacitor (second retention capacitor section) 333 for use in collective charging.

The transistor 334 has its source electrode “s” connected to the drain electrode “d” of a transistor 331 and its gate electrode “g” connected to the gate wire 311b for use in collective charging. The transistor 334 has its drain electrode “d” connected to a storage capacitor (first retention capacitor section) 337 and to the gate electrode “g” of a drive transistor 336.

The retention capacitor 333 has one of its electrodes 333a connected to the drain electrode “d” of the transistor 331 and to the source electrode “s” of the transistor 334. The other electrode 333b of the retention capacitor 333 is connected to a retention capacitor power supply 315.

The retention capacitor 333, arranged from this pair of electrodes 333a and 333b, functions as a capacitor, for use in charging in the pixel, which holds the electric potential to be applied across the storage capacitor 337 so as to turn on the drive transistor 336 temporarily before the electric potential is applied across the storage capacitor 337. In other words, the retention capacitor 333 corresponds to the retention capacitor 33 in the pixel P shown in FIG. 4.

The gate wire 311b for use in collective charging described above supplies a gate signal at such a timing that the transistor 334 in every pixel Pa in the organic EL display panel is simultaneously turned on. Accordingly, all the drive transistors 336 in the organic EL display panel are collectively turned on. In other words, the gate wire 311b corresponds to the gate wire 11b for use in collective charging in the pixel P shown in FIG. 4, and the transistor 334, for use in collective charging, corresponds to the transistor 34 (provided for use in collective charging) in the pixel P shown in FIG. 4.

An arrangement and a driving method similar to those applied to the aforementioned three-dimensional image display system 1 are also applicable to the organic EL display device, except for the arrangement of the pixels Pa, and their detailed descriptions are omitted.

When the present invention is applied to the organic EL display device, there may be provided transistors (third switching elements), for use in collective discharging, which collectively discharge the storage capacitors 337, similarly to a case of the liquid crystal display device.

In the organic EL display device, the common electrode 314 and the electrode 333b may be connected to a single retention capacitor wire (not shown in FIG. 10). When this is the case, a transistor for use in collective discharging is provided between the gate electrode “g” of the drive transistor 336 and the retention capacitor wire. Specifically, the transistor for use in collective discharging has its source electrode connected to the gate electrode “g” of the drive transistor 336 and its drain electrode connected to the retention capacitor wire. The transistor for use in collective discharging then has its gate electrode connected to a gate wire (second control wire) for use in collective discharging (not shown in FIG. 10).

The present invention is not limited to the description of the embodiments above, but may be altered by a skilled person within the scope of the claims. An embodiment based on a proper combination of technical means disclosed in different embodiments is encompassed in the technical scope of the present invention.

A three-dimensional image display device in accordance with the present invention, to attain the aforementioned object, is a three-dimensional image display device for displaying a left-eye image and a right-eye image by time division to realize a three-dimensional image display, the three-dimensional image display device including a display panel, the display panel including: a plurality of data signal lines; a plurality of scan signal lines which intersect the plurality of data signal lines; and a matrix of pixel sections provided corresponding to intersections of the plurality of data signal lines and the plurality of scan signal lines, each of the pixel sections including: a first switching element connected to one of the plurality of scan signal lines and one of the plurality of data signal lines; a first retention capacitor section which contributes to display by storing a data potential supplied via the one of the plurality of data signal lines; a second retention capacitor section for storing the data potential temporarily before the data potential is applied across the first retention capacitor section; and a second switching element provided between the first retention capacitor section and the second retention capacitor section, wherein: in response to a scan signal supplied via the one of the plurality of scan signal lines, the first switching element turns on to apply, to the second retention capacitor section, the data potential supplied via the one of the plurality of data signal lines; and the second switching element is off while the plurality of scan signal lines are being scanned, and upon being switched on, applies the data potential to the first retention capacitor section so as to switch over which one of the left-eye image and the right-eye image is displayed by the pixel sections.

A three-dimensional image display device in accordance with the present invention is a display device effecting a three-dimensional image display by shutter glass technique. The display device in accordance with the present invention includes a matrix of pixel sections each of which is provided with: in addition to a first retention capacitor section (which corresponds to a liquid crystal capacitor in a case of a liquid crystal display device) and a switching element (first switching element) which are included in a typical liquid crystal display panel; a second retention capacitor for temporarily storing a data potential; and a switching element (second switching element) which, upon being turned on while the plurality of scan signal lines are not being scanned (flyback period), applies the data potential to the first retention capacitor section and switches the left-eye image and the right-eye image displayed by the pixel sections.

According to the arrangement, there is provided a second retention capacitor section which stores a data potential temporarily before the data potential is applied across the first retention capacitor section. The plurality of scan signal lines can be thus scanned to sequentially charge the second retention capacitor section in each pixel to a data potential which corresponds to a next set of image data (next frame) while a display is being generated according to a data potential which (i) corresponds to a current set of image data (current frame) and (ii) is being stored in the first retention capacitor section.

Then, by collectively switching the second switching element in each pixel from OFF to ON while the plurality of scan signal lines are not being scanned, the data potential which (i) corresponds to the next set of image data and (ii) has been stored in the second retention capacitor section can be collectively applied across the first retention capacitor section in each pixel section in the display panel.

The first retention capacitor sections which contribute to a display made by the pixels can be thus charged collectively for each frame of image data (on a frame-to-frame basis). Therefore, image “delay” for each frame period, which is unique to those display panels which are subjected to line sequential scanning, occurs less frequently. Hence, when a display device arranged as described above is observed through a pair of shutter glasses, the right-eye image and the left-eye image are prevented from being mixed even if the left-eye shutter and the right-eye shutter of the shutter glasses are designed to be open for a relatively long period. The device therefore enables overlapping images to be restrained and a bright three-dimensional image to be displayed, without increasing frame frequency.

A three-dimensional image display device in accordance with the present invention may be such that: the display panel is a liquid crystal display panel; and the first retention capacitor section includes a pixel electrode and a counter electrode, with liquid crystal in the liquid crystal display panel being interposed between the pixel electrode and the counter electrode.

A three-dimensional image display device in accordance with the present invention may be such that the liquid crystal display panel operates in one of IPS mode, in-plane-electric-field vertical alignment mode, chiral liquid crystal mode, quasi-isotropic liquid crystal mode, and OCB mode.

A three-dimensional image display device in accordance with the present invention may be such that: the display panel is an organic EL display panel including organic EL display elements; the organic EL display panel includes pixel sections in each of which there is further provided a drive transistor for driving the organic EL display elements; and the first retention capacitor section is a storage capacitor for storing electric charge which corresponds to the data potential supplied to the drive transistor.

According to the arrangement, a three-dimensional image display is achieved by shutter glass technique on an organic EL display device subjected to line sequential scanning.

Note that Patent Literature 4 discloses technology to achieve a three-dimensional image display on an organic EL display panel, but the display device described in Patent Literature 4 includes no capacitor (first retention capacitor section) for holding a display. Therefore, unlike the present invention, the technology cannot employ a method for scanning scan signal lines while displaying an image in accordance with a current set of image data in order to supply, to a next set of image data to pixels, data potentials which correspond.

A three-dimensional image display device in accordance with the present invention may further include a first control wire for controlling ON/OFF of the second switching element.

A three-dimensional image display device in accordance with the present invention is preferably such that the first control wire has a width smaller than those of the plurality of scan signal lines.

According to the arrangement, the first control wire has a width smaller than those of the plurality of scan signal lines. This enables a decrease in aperture ratio to be reduced.

A three-dimensional image display device in accordance with the present invention may further include a third switching element, connected to the first retention capacitor section, for discharging the electric charge stored in the first retention capacitor section.

According to the arrangement, the first retention capacitor section can be forcefully discharged. It is therefore possible to efficiently supply, to the first retention capacitor section which contributes to display, the data potential supplied via a corresponding data signal line, so as to obtain a target pixel voltage. It is thus possible to arrange the second retention capacitor section to have a relatively small capacitance.

A three-dimensional image display device in accordance with the present invention may further include a second control wire for controlling ON/OFF of the third switching element.

A three-dimensional image display device in accordance with the present invention is preferably such that the second control wire has a width smaller than those of the plurality of scan signal lines.

According to the arrangement, the second control wire has a width smaller than those of the plurality of scan signal lines. This enables a decrease in aperture ratio to be reduced.

A three-dimensional image display device in accordance with the present invention is preferably such that the first switching element is either a transparent oxide semiconductor TFT or a polysilicon TFT.

According to the arrangement, a high performance switching element with high response speed can be obtained.

A three-dimensional image display system in accordance with the present invention, to attain the object, includes: one of the three-dimensional image display devices; and a shutter section selectively permitting the left-eye image and the right-eye image to pass through the shutter section to reach a left eye and a right eye, respectively, correspondingly to the left-eye image and the right-eye image.

A three-dimensional image display system in accordance with the present invention realizes a three-dimensional image display by shutter glass technique. The three-dimensional image display system in accordance with the present invention includes a three-dimensional image display device in accordance with the present invention, and is therefore capable of displaying a bright three-dimensional image without increasing frame frequency. A viewer viewing an image using a shutter section can hence view a bright three-dimensional image without experiencing overlapping of a left-eye image and a right-eye image.

A three-dimensional image display system in accordance with the present invention may be such that the shutter section is a pair of glasses.

A method of driving a three-dimensional image display device in accordance with the present invention is a method of driving a three-dimensional image display device of the present invention, the method including the steps of: turning on the first switching element, with the second switching element turned off, while a data potential in accordance with a current one of plural sets of image data for time divisional display is stored in the first retention capacitor section, and charging the second retention capacitor section to a data potential in accordance with a next one of the plural sets of image data for time divisional display; and turning on the second switching element in each pixel collectively, with the first switching element turned off, to collectively apply, to the first retention capacitor section in each pixel, the data potential which (i) corresponds to the next set of image data and (ii) has been stored in the second retention capacitor section to realize a display according to the data potential.

According to the method, there is provided a second retention capacitor section which stores a data potential temporarily before the data potential is applied across the first retention capacitor section. The plurality of scan signal lines can be thus scanned to sequentially charge the second retention capacitor section in each pixel to a data potential which corresponds to a next set of image data (next frame) while a display is being generated according to a data potential which (i) corresponds to a current set of image data (current frame) and (ii) is being stored in the first retention capacitor section.

Then, by collectively switching the second switching element in each pixel from OFF to ON while the plurality of scan signal lines are not being scanned, the data potential which (i) corresponds to the next set of image data and (ii) has been stored in the second retention capacitor section can be collectively applied across the first retention capacitor section in each pixel section in the display panel.

The first retention capacitor sections which contribute to a display made by the pixels can be thus charged collectively for each frame of image data (on a frame-to-frame basis). Therefore, image “delay” for each frame period, which is unique to those display panels which are subjected to line sequential scanning, occurs less frequently. Hence, when an image displayed by the method is viewed through a pair of shutter glasses, the right-eye image and the left-eye image are prevented from being mixed even if the left-eye shutter and the right-eye shutter of the shutter glasses are designed to be open for a relatively long period. The method therefore enables overlapping images to be restrained and a bright three-dimensional image to be displayed, without increasing frame frequency.

A method of driving a three-dimensional image display device in accordance with the present invention is a method of driving a three-dimensional image display device of the present invention, the method including the steps of: turning on the first switching element, with the second switching element and the third switching element turned off, while a data potential in accordance with a current one of plural sets of image data for time divisional display is stored in the first retention capacitor section, and charging the second retention capacitor section to a data potential in accordance with a next one of the plural sets of image data for time divisional display; in each pixel, collectively turning on the third switching element with the second switching element turned off, to collectively cause the first retention capacitor section in each pixel to discharge the data potential in accordance with the current set of image data; and turning on the second switching element in each pixel collectively, with the first switching element and the third switching element turned off, to collectively apply, to the first retention capacitor section in each pixel, the data potential which (i) corresponds to the next set of image data and (ii) has been stored in the second retention capacitor section to realize a display according to the data potential.

According to the method, there is provided a second retention capacitor section which stores a data potential temporarily before the data potential is applied across the first retention capacitor section. The plurality of scan signal lines can be thus scanned to sequentially charge the second retention capacitor section in each pixel to a data potential which corresponds to a next set of image data (next frame) while a display is being generated according to a data potential which (i) corresponds to a current set of image data (current frame) and (ii) is being stored in the first retention capacitor section.

Thereafter, the third switching element for use in discharging in each pixel is collectively switched from OFF to ON while the plurality of scan signal lines are not being scanned, so that the first retention capacitor section in each pixel in the display panel can collectively discharge the data potential in accordance with the current set of image data.

Then, in each pixel, by collectively switching the third switching element from ON to OFF and switching the second switching element from OFF to ON simultaneously while the plurality of scan signal lines are not being scanned, the data potential which (i) corresponds to the next set of image data and (ii) has been stored in the second retention capacitor section can be collectively applied across the first retention capacitor section in each pixel section in the display panel.

The first retention capacitor sections which contribute to a display made by the pixels can be thus discharged and charged collectively for each frame of image data (on a frame-to-frame basis). Therefore, image “delay” for each frame period, which is unique to those display panels which are subjected to line sequential scanning, occurs less frequently. Hence, when an image displayed by the method is viewed through a pair of shutter glasses, the right-eye image and the left-eye image are prevented from being mixed even if the left-eye shutter and the right-eye shutter of the shutter glasses are designed to be open for a relatively long period. The method therefore enables overlapping images to be restrained and a bright three-dimensional image to be displayed, without increasing frame frequency.

The embodiments and concrete examples of implementation discussed in the foregoing detailed description serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention realizes a good three-dimensional image display. Therefore, the present invention is applicable to display devices and display systems for a three-dimensional display (3D display).

### REFERENCE SIGNS LIST

1 Three-dimensional Image Display System
10 Liquid Crystal Display Device (Display Device)
11a Gate Wire for Use in Scanning (Scan Signal Line)
11b Gate Wire for Use in Collective Charging (First Control Wire)
11c Gate Wire for Use in Collective Discharging (Second Control Wire)
12 Source Wire (Data Signal Line)
14 Counter Electrode (First Retention Capacitor Section)
16 Retention Capacitor Line
20 Shutter Glasses (Shutter Section)
30 Pixel Electrode (First Retention Capacitor Section)
31 Transistor (First Switching Element)
32 Liquid Crystal Capacitor (First Retention Capacitor Section)
33 Retention Capacitor (Second Retention Capacitor Section)
34 Transistor for Use in Collective Charging (Second Switching Element)
35 Transistor for Use in Collective Discharging (Third Switching Element)
101 Image Data Output Section
102 Liquid Crystal Display Panel (Display Panel)
103 Liquid Crystal Shutter Control Section (Shutter Control Section)
104 Liquid Crystal Shutter L (Left-eye Shutter)
105 Liquid Crystal Shutter R (Right-eye Shutter)
106 Frame Data
107 Frame Control Signal
108 Liquid Crystal Shutter L Control Signal
109 Liquid Crystal Shutter R Control Signal
111 Glasses Section
311a Gate Wire for Use in Scanning (Scan Signal Line)
311b Gate Wire for Use in Collective Charging (First Control Wire)
312 Source Wire (Data Signal Line)
315 Retention Capacitor Power Supply
331 Transistor (First Switching Element)
332 Organic EL Element
333 Retention Capacitor (Second Retention Capacitor Section)
334 Transistor (Second Switching Element) for Use in Collective Charging
336 Drive Transistor
337 Storage Capacitor (First Retention Capacitor Section)
P Pixel (Pixel Section for Liquid Crystal Display Panel)
P2 Pixel (Pixel Section for Liquid Crystal Display Panel)
Pa Pixel (Pixel Section for Organic EL Display Panel)

1. A three-dimensional image display device for displaying a left-eye image and a right-eye image by time division to realize a three-dimensional image display,
said three-dimensional image display device comprising a display panel,
the display panel including:
a plurality of data signal lines;
a plurality of scan signal lines which intersect the plurality of data signal lines; and
a matrix of pixel sections provided corresponding to intersections of the plurality of data signal lines and the plurality of scan signal lines,
each of the pixel sections including:
a first switching element connected to one of the plurality of scan signal lines and one of the plurality of data signal lines;
a first retention capacitor section which contributes to display by storing a data potential supplied via the one of the plurality of data signal lines;
a second retention capacitor section for storing the data potential temporarily before the data potential is applied across the first retention capacitor section; and
a second switching element provided between the first retention capacitor section and the second retention capacitor section,
wherein:
in response to a scan signal supplied via the one of the plurality of scan signal lines, the first switching element turns on to apply, to the second retention capacitor section, the data potential supplied via the one of the plurality of data signal lines; and
the second switching element is off while the plurality of scan signal lines are being scanned, and upon being switched on, applies the data potential to the first retention capacitor section so as to switch over which one of the left-eye image and the right-eye image is displayed by the pixel sections.

2. The three-dimensional image display device as set forth in claim 1, wherein:
the display panel is a liquid crystal display panel; and
the first retention capacitor section includes a pixel electrode and a counter electrode, with liquid crystal in the liquid crystal display panel being interposed between the pixel electrode and the counter electrode.

3. The three-dimensional image display device as set forth in claim 2, wherein
the liquid crystal display panel operates in one of IPS mode, in-plane-electric-field vertical alignment mode, chiral liquid crystal mode, quasi-isotropic liquid crystal mode, and OCB mode.

4. The three-dimensional image display device as set forth in claim 1, wherein:
the display panel is an organic EL display panel including organic EL display elements;
each of the pixel sections of the organic EL display panel is further provided with a drive transistor for driving the organic EL display elements; and
the first retention capacitor section is a storage capacitor for storing electric charge which corresponds to the data potential supplied to the drive transistor.

5. The three-dimensional image display device as set forth in claim 1, further comprising a first control wire for controlling ON/OFF of the second switching element.

6. The three-dimensional image display device as set forth in claim 5, wherein
the first control wire has a width smaller than those of the plurality of scan signal lines.

7. The three-dimensional image display device as set forth in claim 1, further comprising a third switching element, connected to the first retention capacitor section, for discharging the electric charge stored in the first retention capacitor section.

8. The three-dimensional image display device as set forth in claim 7, further comprising a second control wire for controlling ON/OFF of the third switching element.

9. The three-dimensional image display device as set forth in claim 8, wherein
the second control wire has a width smaller than those of the plurality of scan signal lines.

10. The three-dimensional image display device as set forth in claim 1, wherein
the first switching element is either a transparent oxide semiconductor TFT or a polysilicon TFT.

11. A three-dimensional image display system, comprising:
the three-dimensional image display device as set forth in claim 1; and
a shutter section selectively permitting the left-eye image and the right-eye image to pass through the shutter section to reach a left eye and a right eye, respectively, correspondingly to the left-eye image and the right-eye image.

12. The three-dimensional image display system as set forth in claim 11, wherein the shutter section is a pair of glasses.

13. A method of driving the three-dimensional image display device as set forth in claim 1, said method comprising the steps of:
turning on the first switching element, with the second switching element turned off, while a data potential in accordance with a current one of plural sets of image data for time divisional display is stored in the first retention capacitor section, and charging the second retention capacitor section to a data potential in accordance with a next one of the plural sets of image data for time divisional display; and
turning on the second switching element in each pixel collectively, with the first switching element turned off, to collectively apply, to the first retention capacitor section in each pixel, the data potential which (i) corresponds to the next set of image data and (ii) has been stored in the second retention capacitor section to realize a display according to the data potential.

14. A method of driving the three-dimensional image display device as set forth in claim 7, said method comprising the steps of:
turning on the first switching element, with the second switching element and the third switching element turned off, while a data potential in accordance with a current one of plural sets of image data for time divisional display is stored in the first retention capacitor section, and charging the second retention capacitor section to a data potential in accordance with a next one of the plural sets of image data for time divisional display;
in each pixel, collectively turning on the third switching element with the second switching element turned off, to collectively cause the first retention capacitor section in each pixel to discharge the data potential in accordance with the current set of image data; and
turning on the second switching element in each pixel collectively, with the first switching element and the third switching element turned off, to collectively apply, to the first retention capacitor section in each pixel, the data potential which (i) corresponds to the next set of image data and (ii) has been stored in the second retention capacitor section to realize a display according to the data potential.
